(19) United States
(12) Patent Application Publication
(10) Pub. No.: US 2007/0258792 A1
(43) Pub. Date: Nov. 8, 2007

(54) ANCHOR FASTENING DEVICE FOR FLUSH MOUNTING OF STRUCTURES

(76) Inventor: Richard A. Pavlov, Manitowish Waters, WI (US)

Correspondence Address: LANE PATENTS LLC, 100 NORTH 72ND AVE., SUITE 107, WAUSAU, WI, 54401, US

(21) Appl. No.: 11/687,603

(22) Filed: Mar. 16, 2007

Related U.S. Application Data
(63) Continuation-in-part of application No. 60/746,591, filed on May 5, 2006.

(51) Int. Cl. F16B 37/00; E04B 1/38

(52) U.S. Cl. 411/439

(57) ABSTRACT

An improved apparatus for the flush mounting of wood structures such as top plates which does not require counter sinking a hole for a bolt and washer. This fastener device has a larger flange area and made of thicker materials than found in the prior art. This gives the present invention added utility when under severe environmental stresses, found in the construction codes.

This invention also has the advantages of installing on a bolt that does not protrude a sufficient distance above the surface of the wood. It is also self centering and can act as a separation between the bolt and the wood.

The invention utilizes an inverted nut (female) flanged anchor fastening device in combination with a faceted (male) driver with a hollowed annular region for driving for driving the anchor fastening device into place.

In certain embodiments, the present design can be inverted and mounted to the bottom side of the top plate between the foundation and the top plate. This gives the added advantage of setting the depth and angle at which the anchor bolt protrudes from the foundation. This eliminates the extra labor to cut the anchor bolt flush with the flat top fastener.

### CROSS-REFERENCE TO RELATED APPLICATIONS

The present application is a continuation-in-part application of U.S. provisional patent application, Ser. No. 60/746,591, filed May 5, 2006, for ANCHOR FASTENING DEVICE FOR FLUSH MOUNTING OF TOP PLATES, included by reference herein and for which benefit of the priority date is hereby claimed.

### BACKGROUND OF THE INVENTION

1. Field of the Invention

The present invention relates generally to the construction arts. In particular, to the flush mounting of top plates such as top plates to foundations members through the use of load bearing surfaces attached to anchor bolts. In general, this device can be used to mount any bolted wood structure where flush mounting is desired either vertically or horizontally.

2. Description of the Related Art

The relevant art of interest describes various fasteners, in particular bolt and nut combinations used to secure walls and other structural members to structural foundations.

In construction the top plate such as a sill plate is typically fastened to a structural foundation by means of placing a fastener, typically placing a washer and threading a nut, onto an anchor bolt which protrudes through the sill plate and is embedded into concrete footings. The washer and nut typically protrude above the surface of the top plate.

In other construction practices, the top plate may represent a board, a panel, or other member needing to be securely anchored to a beam, pillar, post or other vertical member forming the foundation of the particular structure.

These systems must be robust against environmental stresses such as earthquakes, hurricanes, snow loads and the like. Therefore each anchor bolt must be secure and the fastener must be able to adequately grip the top plate even when the anchor bolt does not extend above the surface of the top plate.

In the current building practice, to provide sufficient threading area, the threaded portion of the anchor bolt can protrude above the surface of a sill plate by as much as 2 inches or more while framing a structure. Protruding anchor bolts cause a tripping hazard when walking the top plate during construction. This can cause problems later on in the construction process when the flooring system is installed It is current practice to require an additional operation to manually cut the top of any protruding bolt to allow the flooring system to be properly installed.

Many times the hole through the top plate is countersunk approximately ¾ inch or more to allow the anchor bolt to be flush with the top of the top plate. This, however, weakens the top plate which is frowned upon under today's building codes and standards. This method of countersinking also requires additional labor and is prone to mistakes of drilling the countersink hole too deep.

Sometimes, when attempting to set the anchor bolt flush with the top surface of the top plate, the bolt protrudes an insufficient distance from the surface of the top plate to allow a secure threading connection. When this happens, the defect has to be reworked.

U.S. Pat. No. 6,460,308 issued Oct. 8, 2002 to Armstrong et al.; discloses a rework scheme which requires a combination nut-sleeve having a continuous internal thread, and an elongate cap sized to cover the anchor bolt. The cap is then removed and the nut-sleeve combination installed. This system requires removing material from the top plate, which is labor intensive, and reduces the amount of top plate that can be gripped by the fastener.

Others have attempted to devise separate anchoring plates to be used to increase the load distribution between the top plate and the anchor bolt. U.S. Pat. No. 6,105,332 issued Aug. 22, 2000 to Boyadjian, and U.S. Pat. No. 5,546,723 issued Aug. 20, 1996 to Jones; disclose variations on anchor plates designed to distribute load between the top plate and the anchor bolt. These disclosures present at least two problems. First is the fact that these solutions require an additional construction step with a separate apparatus to be installed during the construction process. Secondly, an added apparatus above the top plate, further extends the height that the anchor nut is installed above the top plate, which can pose problems during subsequent operations.

U.S. Pat. No. 3,305,987 issued Feb. 28, 1967 to Weaver; teaches a joist support structure which has a flange. It is rotated into place by a nut portion which then protrudes from the top of the top plate. In a separate embodiment, such as FIG. 13, it can also take the form of a washer which then utilizes a separate nut to drive and hold it into place. One distinguishing feature is a groove cutter, col 2 line 21, “adapted to cut itself into the face of the beam”. This cutting creates, in essence, a wooden plug attached to the anchor bolt that, when stressed, can break away from the top plate. This type of practice is generally discouraged by today's building practices. The current invention is distinguishable by not cutting into the face of the beam. Another distinction of the present invention is the nut portion is inverted to seat below the wood, which makes it fit flush to the top plate.

U.S. Pat. No. 2,632,355 issued Mar. 18, 1949 to Becker; discloses a flanged nut which consists of a non-resilient deformable section near the barrel or shank with a cold worked, hardened embossed portion spaced apart from the shank (see claim 1). It is driven into place by a polygonal tool-engaging peripheral edge, which when combined with the relatively large and flat flanged area of the present invention, creates problems with the driving tool not fully engaging with all the edges, causing stripping of the bolt portion and incomplete driving of the flanged nut. The current invention is also distinguishable by having a shoulder portion between the flange and the barrel to provide an interface between the two. It also is driven into place with an inverted nut formed on the opposite side of the shoulder which provides a superior means of driving the nut onto the bolt avoiding the problems mentioned above.

The Becker patent disclosed above is the fore-bearer to many of the flanged nuts such as those found in www.indexfastners.com product catalogue for example. Typically these fall into two broad categories, weld nuts and pallet nuts.

Weld nuts are used to provide threaded region for attaching bolts in metal construction arts. They are designed to be pounded into a hole drilled into a piece of metal and tack welded into place. The bolt is then tightened in to the stationary nut from the opposite end. These nuts do not have the shoulder element of the present invention, because they are meant to fit into a small diameter hole. Also, because they are welded into place with the bolt being turned from the opposite end, they do not have sufficient torque means required for driving onto an anchor bolt for a top plate.

Pallet nuts are used to construct light duty assemblies such as pallets, furniture, or shipping boxes. Some have a means for being tightened by a hex key which can be inserted into the center of the barrel. Therefore the pallet nut is designed with the threaded portion of the barrel extending only partially through the barrel with the remainder of the barrel being formed for insertion of a solid hex key. This posses a problem for the application of top plates in that insertion of a hex key, or other such tightening means, into the top of the barrel to tighten the nut interferes with the setting of the bolt height which ideally should travel to the top of the nut or slightly beyond in order to securely hold the top plate. Therefore an ideal solution must not interfere with the depth of the nut onto the bolt. The current invention is distinguishable for having a threaded inside portion which extends through the entire barrel and a faceted driver with a hollow cavity larger than the diameter of an anchor bolt to receive anchor bolts tips to allow it to extend through the barrel as needed.

The flanged nuts as found in the prior art are also inferior in that the flanged portion for a ½ inch diameter anchor bolt is less than 1¼ square inches, which is not satisfactory to bear the load needed to hold the top plate during environmental stresses such as those exerted by an earthquake, floodwaters, storms or high winds.

There are several inventions intended to set and maintain the anchor bolt in the foundation itself.

Publication No. US 2005/0120665 by Anderson Jr. discloses an anchor bolt protection apparatus which slips over the top of the anchor bolt under top plate to keep the possibly treated lumber of the top plate from contacting and corroding the anchor bolt.

U.S. Pat. No. 6,347,916 issued Feb. 19, 2002 to Rameriz discloses a similar invention intended to level and set the height of the anchor bolt by employing a large flange like member set at a given space below the top surface of the anchor bolt.

Japanese Pat. No. JP404312653 published Nov. 4, 1992 to Sakata also discloses a screwing support plate that can be used to more precisely set the both the level of the foundation that the top plate would sit upon and the height that the bolt would protrude above the foundation.

### BRIEF DESCRIPTION OF THE INVENTION

### Summary

The present invention relates to an anchor fastener device with a preferred embodiment having a shoulder region between the barrel and the flange to spread the load over a larger surface area than is found in ordinary weld and pallet nut designs. This design element further strengthens that intersection which can be the weakest part of the standard weld nut system under stress.

The top side of the shoulder region can be faceted in such a way as to receive a driver to the interior of the perimeter. The threading on the inside portion of the barrel extends completely through the barrel. This allows an anchor bolt to extend through the entire barrel section. In order to tightly cinch an anchor fastening device, in a case where the bolt may protrude through the top, a hollow region or cavity has been formed inside the faceted driving tool to allow the anchor bolt to slip inside while fastening. In addition the anchor fastening device has a larger flange area which is also thicker than found in the prior art.

Embodiments of the present invention can be formed by machining hardened metal or the traditional punching and drawing operations.

In addition, embodiments of the present invention, with a reduced shoulder region, can be inverted and threaded to the bottom side of the top plate between the foundation and the top plate. This gives the added advantage of presetting the depth and angle at which the lag bolt protrudes up from a foundation.

Both the bottom and top plates can be made of materials such as steel, zinc plated, nickel hardened, stainless, or other comparable ferric materials. In addition, hardened plastic such as glass reinforced nylon or celazole for mass manufacturability, lower cost, and reduced galvanic corrosion.

### OBJECTS AND ADVANTAGES

Advantages for the present invention include replacing the multiple components of washer and nut with a one piece fastening device.

A further advantage is that the present invention seats substantially flush with the top of the top plate which better facilitates flooring system installation.

A further advantage is that the present invention seats substantially flush with the top of the top plate which reduces the tripping hazard and adds to the safety on the construction site.

A further advantage is that the present invention has an enlarged flange surface area greater than 1.23 square inches (or 1¼ inch diameter) in one embodiment to adequately grip the top plate under extreme environmental stress.

A further advantage is that the present invention can compensate when, during the construction process, the anchor bolt protrudes an insufficient distance from the surface of the top plate to allow a threading connection above the top plate. Thus eliminating costly rework of the system as taught in the Armstrong patent.

A further advantage is that the present invention does not require additional anchoring plates to distribute the load, as shown in Boyadjian and Jones patents.

A further advantage is that the present invention does not score or cut itself into the face of the wood in order to secure the top plate.

A further advantage of the present invention is that the same apparatus can be inverted to sit under the top plate to level and set the height of the anchor bolt.

### DRAWING FIGURES

FIG. 1 is a sectional view of top plate system and anchor fastening device of the present invention.

FIG. 2 is a perspective view of the top plate system and anchor fastening device of the present invention.

FIG. 3a, b, and c are respectively front side, side section, and perspective views of a preferred embodiment of the present invention.

FIG. 4 is a front exploded view of one embodiment of an anchor fastening device including a matching driving tool of the present invention.

FIG. 5a, b, and c are respectively front side, side section and perspective views of yet another embodiment of the anchor fastening device of the present invention.

FIG. 6a, and b are respectively front side and side section views of yet another embodiment of the anchor fastening device of the present invention.

FIG. 7 is a front perspective view of one embodiment of an anchor fastening device including a matching driving tool of the embodiment shown in FIG. 6 of the present invention.

FIG. 8 is a perspective view of one embodiment of the present invention being applied using a driving tool.

FIG. 9 is a front side view of an alternate embodiment of the present invention,

FIG. 10 shows a sectional view of one embodiment of the present invention at the point of assembly.

FIG. 11 shows a sectional view of an alternate embodiment of the present invention.

### DETAILED DESCRIPTION OF THE DRAWINGS

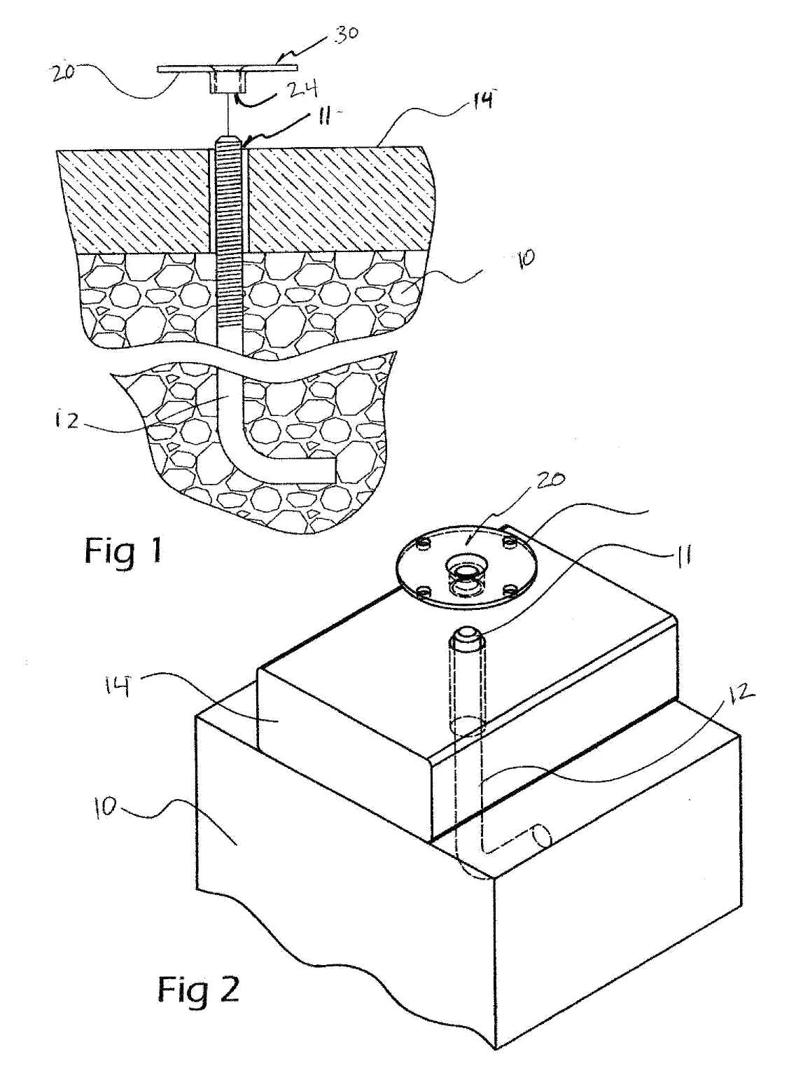

In reference to the drawings, FIGS. 1 and 2 show an anchor substrate (10) with an embedded anchor bolt (12) extending out of the anchor substrate (10) and protruding through a hole drilled all the way through the top plate (14) and ending substantially flush with the top thereof.

The anchor fastening device (20) is secured by engaging the threaded annular cylinder (24) of the anchor fastening device (20) to the threaded portion (11) of the anchor bolt (12) and torquing the device (20) until the flange (30) tightly engages the top surface of the top plate (14). This has the effect of countersinking the barrel (22) of the device (20) into the hole drilled through the top plate (14).

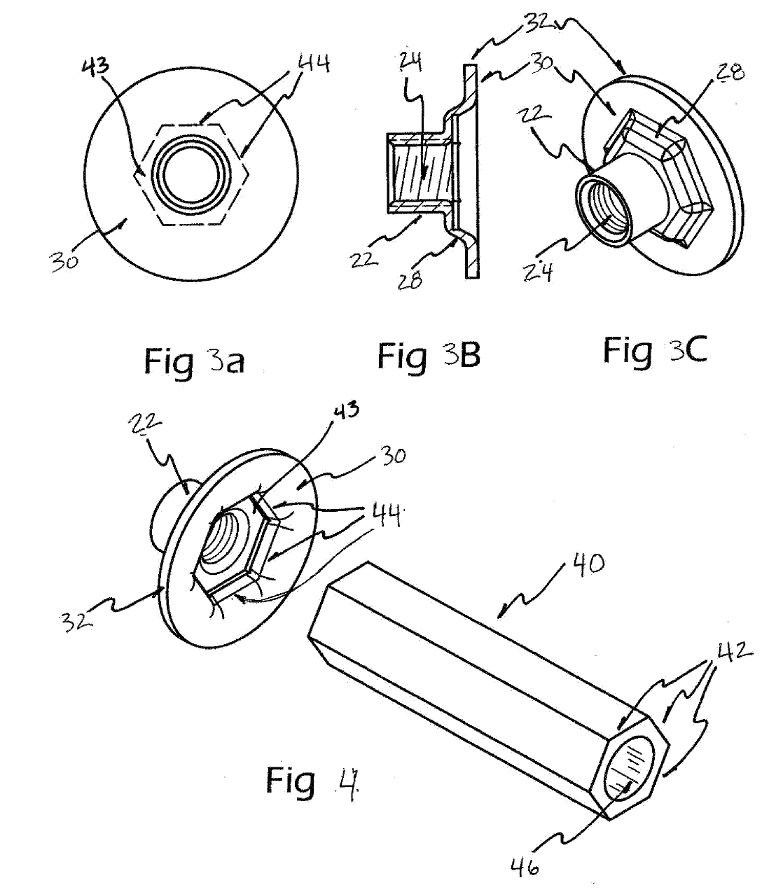

FIG. 3 shows a preferred embodiment of an anchor fastening device (20) of the present invention. This device (20) is essentially comprised of a barrel (22) surrounding a threaded annular cylinder (24) which functions to engage the threaded portion (11) of an anchor bolt (12). A shoulder (28) is found between the barrel (22) and the flange (30). One purpose of the shoulder (28) is to provide load bearing capability near the barrel flange intersection (26) of the device (20) which, many times, is the weakest point of the system. Immediately attached to the shoulder (28) and on the opposite end of the barrel (22) is a flange (30). The flange (30) must be of sufficient load bearing surface area to keep the top plate from ripping through the wood. In Florida, for example, the washer size in the current specifications can be as large as 2 square inches. A typical pallet nut with a nominal half inch barrel is less than 1 inch diameter. The current invention teaches at least a 1 inch diameter, and preferably a 1¼ inch diameter to provide sufficient load bearing surface area. The flange edge (32) must also be of sufficient thickness not to snap or buckle under load.

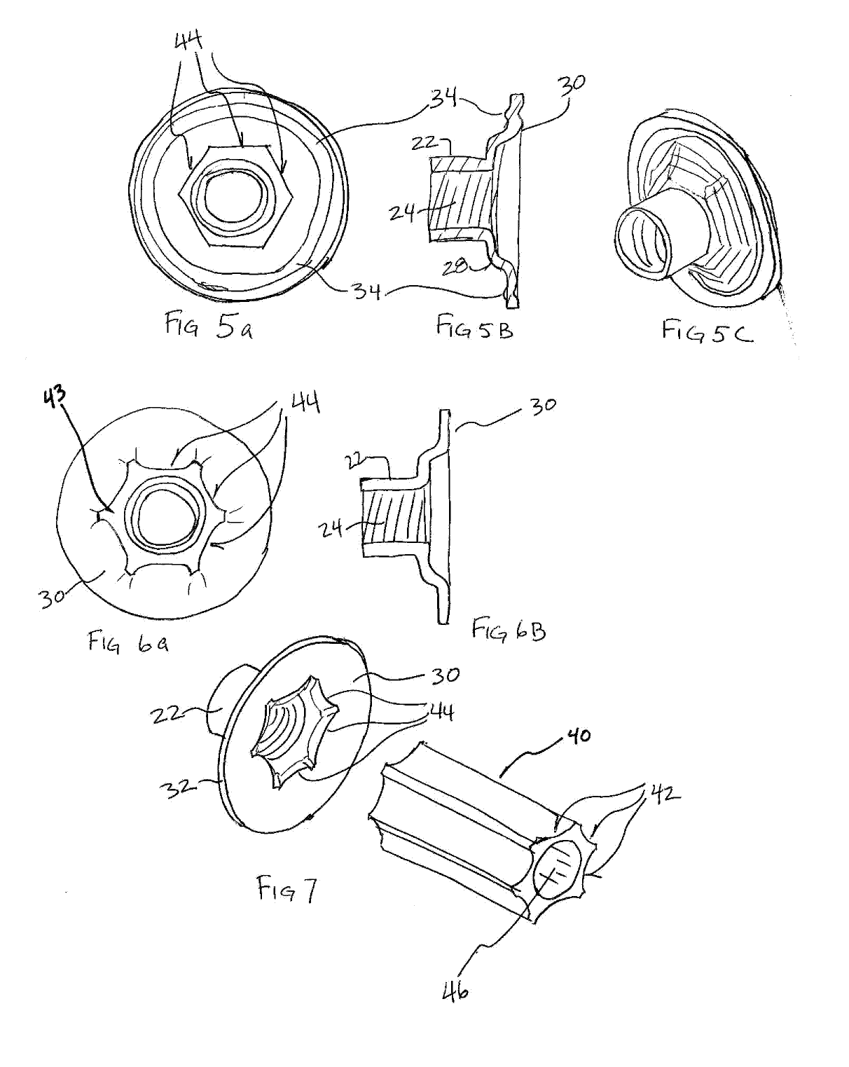

FIGS. 4 and 7 show front exploded views of various embodiments of an anchor fastening device (20) with a driving tool (40) ready to engage for torquing into place. This is done by inserting the driving tool (40) into the inverted nut (43) which generally consists of receiving facets (44) which are designed to be engaged by the driving facets (42) of the driving tool (40). While the inverted nut is generally in the shape of a hexagon, or other polygon, it should be apparent to one skilled in the art that there are other shapes such as the concave facets shown in FIG. 6a, and others. The key principle being facets that engage between the driving tool (40) and the inverted nut (43) be substantially inverted forms of one another, and that sufficient facets or points be provided for torquing the anchor fastening device (20).

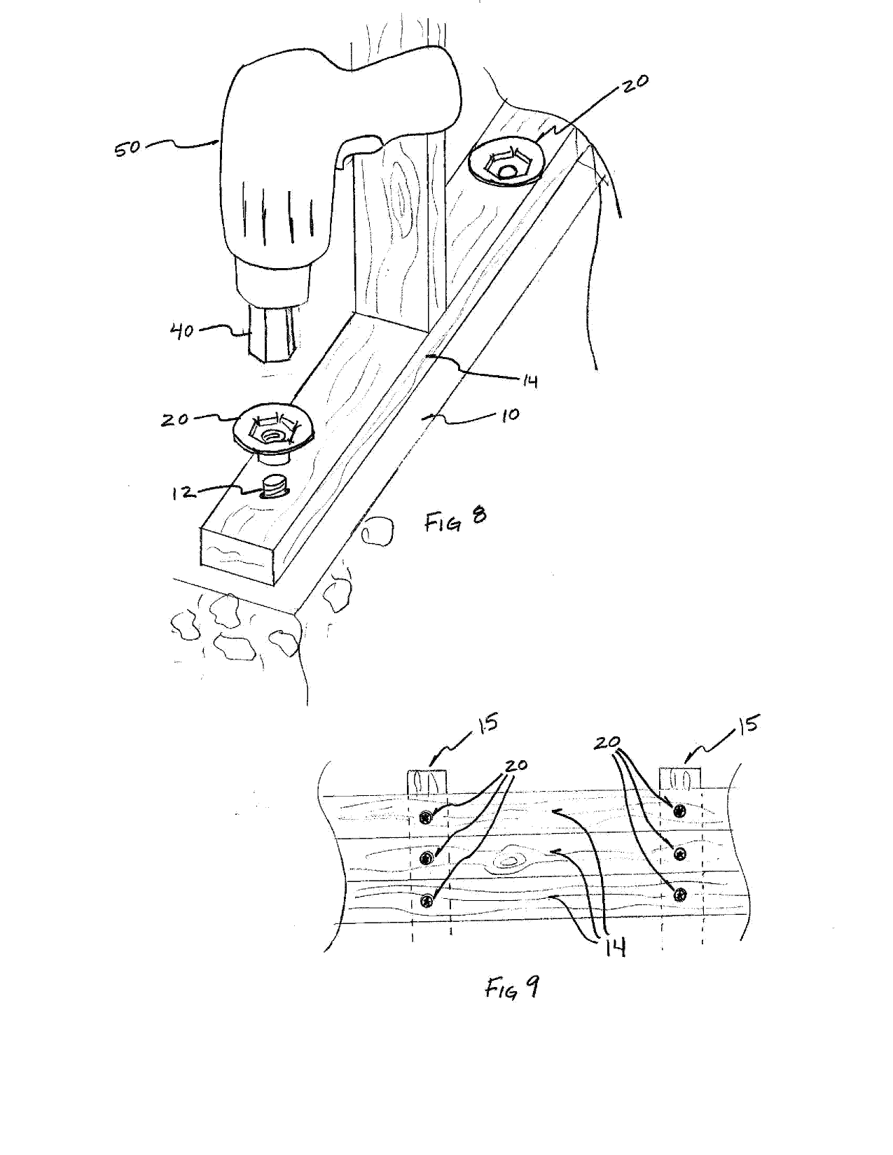

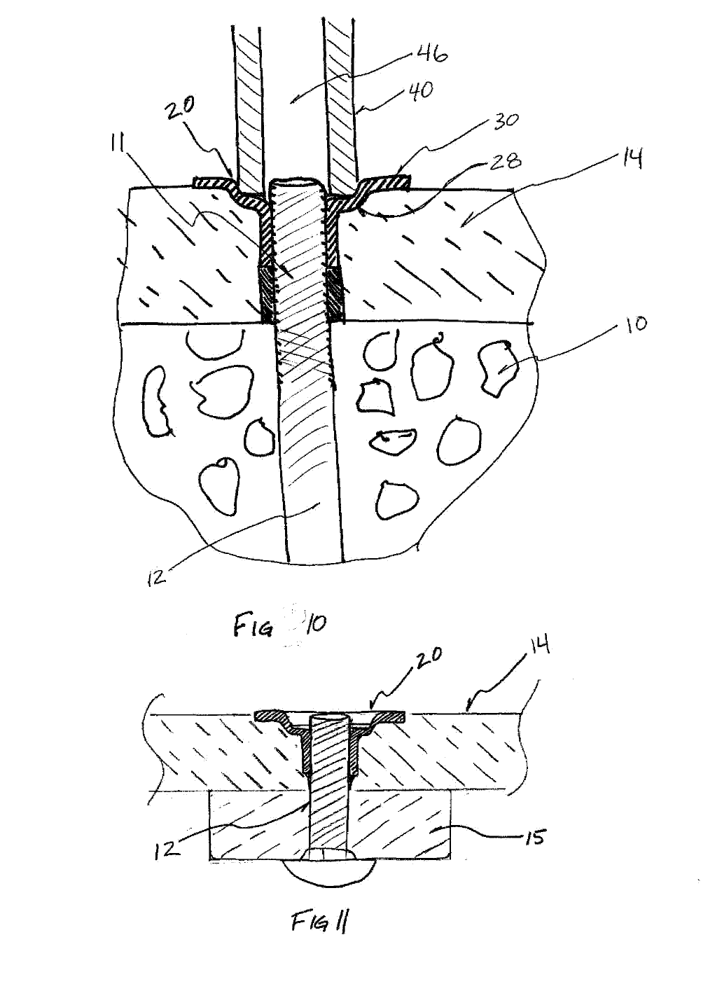

FIG. 9 shows an alternate embodiment comprising anchor pillars (15) running transversal to a succession of top plates (14) being held in place with a series of anchor fastening devices (20). This and similar structures can be used for support walls, piers and the like. FIG. 11 shows further detail in a sectional view of with such and arrangement having carriage bolt to function as the anchor fastening device (20).

FIG. 10 shows another salient feature of the driving tool (40) is that it contains an hollow cavity (46) slightly larger than the diameter of the anchor bolt (12) such that the anchor bolt (12) can protrude through the barrel and into the inverted nut (43) region, the driving tool (40) will not be pushed out of position. Also note that the shoulder (28) pushes into the top plate (14) deforming it Lightly. This provides for tight fit which is much less likely to work its way loose over time.

FIG. 5a, b, c show an alternate embodiment of the anchor fastening device (20) shown in FIG. 3, which contains an annular depression (34). The annular depression (34) provides yet another way for the flange (30) to protrude into the top plate (14).

FIG. 8 shows a wrenching tool (50) with a driving tool (40) premounted and ready to engage an anchor fastening device (20) into a top plate (14). It should be noted that there are a variety of ways to wrench the anchor fastening device (20) both manually and by power means.

FIG. 10 shows an anchor bolt (12) protruding through an anchor substrate (10) and through a hole which extends through a top plate (14). An anchoring device (20) is threaded through the top portion of the threaded portion of the anchor bolt (ii) and snuggly engaged with the top plate (14). The driving tool (40) is still engaged showing the hollow cavity (46) extending below the of the anchor bolt (14). It may also be noted that the shoulder (28) of the anchoring device (20) is pressed into the top plate (28) in such a way as to concentrate the load at that across its surface.

### CONCLUSION, RAMIFICATIONS, AND SCOPE

Although the present invention had been described in detail, those skilled in the art will understand that various changes, substitutions, and alterations on the anchor fastening device or driving tool or methods used herein may be made without departing from the spirit and scope of the invention in its broadest form.

What is claimed is:

1. An anchor fastening device for flush mounting of top plates for anchoring walls and other structures to structural foundations, comprising:
means for providing an anchor substrate for forming a foundation;
means for providing a plurality of anchor bolts, with means for threading, at substantially regularly spaced intervals throughout said anchor substrate, for receiving top plates;
means for providing a top plate with through holes, slightly larger than the diameter of said anchor bolts, which substantially match said anchor bolt locations;
means for mounting said top plate onto said anchor substrate such that said anchor bolts penetrate said through holes;
means for providing a plurality of anchor fastening devices with means for threading;
means for mounting said anchor fastening devices onto said anchor bolts;
means for cinching said anchoring devices onto said anchor bolts with said means for threading;
means for bearing the load of the top plate, rigidly connected to said means for securing a top plate to a foundation;
means for extending between the wrenching means and the anchor fastening device to drive it into position;
means for engaging with the receiving facets to torque the anchor fastening device into position, coaxially encompassing said means for extending between the wrenching means and the anchor fastening device to drive it into position; and
means for proving a void for the anchor bolt to extend flush with or through the top of the threaded annular cylinder, cylindrically enveloping to said means for engaging with the receiving facets to torque the anchor fastening device into position.

2. The anchor fastening device for flush mounting of top plates in accordance with claim 1, wherein said means for engaging with the receiving facets to torque the anchor fastening device into position comprises substantially flat driving facets.

3. The anchor fastening device for flush mounting of top plates in accordance with claim 1, wherein said means for engaging with the receiving facets to torque the anchor fastening device into position comprises substantially concave driving facets.

4. The anchor fastening device for flush mounting of top plates in accordance with claim 1, wherein said means for threading comprises a barrel having a threaded portion having a threaded portion which extends substantially through entire said barrel.

5. The anchor fastening device for flush mounting of top plates in accordance with claim 1, wherein said means for bearing the load of the top plate comprises a load bearing, flange surface area greater than 1¼ square inch.

6. The anchor fastening device for flush mounting of top plates in accordance with claim 5, wherein said means for bearing the load of the top plate comprises a load bearing, flange thickness is greater than 0.09 inch.

7. An anchor fastening device and driving tool for flush mounting of top plates for anchoring walls and other structures to building foundations, comprising:
an anchor bolt, for anchoring a top plate to an anchor substrate;
a flush mounting anchor fastening device, for securing a top plate to a foundation;
a cylindrical barrel, for housing the threaded annular cylinder, rigidly connected to said anchor fastening device;
a threaded annular cylinder, for cinching anchoring device onto bolt, rigidly connected to said barrel;
a load bearing flange, with sufficient surface area for bearing the load of the top plate, rigidly connected to said anchor fastening device;
a torquing, hollow cavity cylinder driving tool, for extending between the wrenching means and the anchor fastening device to drive it into position;
a substantially flat, substantially concave driving facets, for engaging with the receiving facets to torque the anchor fastening device into position, coaxially encompassing to said driving tool; and
a rigid annular hollow, for proving a void for the anchor bolt to extend flush with or through the top of the threaded annular cylinder, cylindrically enveloping to said driving facets.

8. The anchor fastening device for flush mounting of top plates as recited in claim 7, further comprising:
a load distributing, self aligning shoulder, for providing an area of increased pressure for load distribution and centering, rigidly connected to said anchor fastening device, and rigidly connected to said receiving facets.

9. The anchor fastening device for flush mounting of top plates as recited in claim 7, further comprising:
wrenching facets which are interior to the perimeter of the flange.

10. The anchor fastening device for flush mounting of top plates as recited in claim 8, further comprising:
a flange edge, for increasing load bearing capacity.

11. The anchor fastening device for flush mounting of top plates as recited in claim 8, further comprising:
an annular depression, for alternate embodiments.

12. The anchor fastening device for flush mounting of top plates as recited in claim 10, further comprising:
an annular depression, for alternate embodiments.

13. An anchor fastening device for flush mounting of top plates for anchoring walls and other structures to building foundations, comprising:
a cement or similar substance anchor substrate, for providing a foundation in which a plurality of anchor bolts are retained;
a plurality of anchor bolts, for anchoring the top plate to the anchor substrate, rigidly connected to said anchor substrate;
a wood or similar material top plate, for forming structural members, securably fastened to said plurality of anchor bolts;
a plurality of flush mounting anchor fastening devices, for securing a top plate to a foundation;
a cylindrical barrel, for housing the threaded annular cylinder, rigidly connected to said anchor fastening device;
a threaded annular cylinder, for for cynching anchoring device onto bolt, rigidly connected to said barrel;
a barrel flange intersection, for connecting the barrel to the flange;
a load distributing, self aligning shoulder, for providing an area of increased pressure for load distributoin and centering, rigidly connected to said anchor fastening device;
a load bearing, sufficient surface area flange, for bearing the load of the top plate, rigidly connected to said anchor fastening device;
a flange edge, for <purpose>;
an annular depression, for alternate embodiments;
a torquing, hollow annular cylinder driving tool, for extending between the wrenching means and the anchor fastenting device to drive it into position;
a substantially flat, substantially concave driving facets, for engaging with the receiving facets to torque the anchor fastening device into position, coaxially encompassing to said driving tool;
a matches the inverse of the driving tool receiving facets, for <purpose>, releasably assembled to said driving facets, and rigidly connected to said shoulder; and
a rigid hollow cavity, for proving a void for the anchor bolt to extend flush with or through the top of the threaded annular cylinder, cylindrically enveloping to said driving facets.
